(19) United States
(12) Patent Application Publication
(10) Pub. No.: US 2019/0039879 A1
(43) Pub. Date: Feb. 7, 2019

(54) Saddle Pad

(71) Applicant: HRP Equestrian Limited, London (GB)

(72) Inventor: Helen Ross, Canterbury (GB)

(73) Assignee: HRP Equestrian Limited, London (GB)

(21) Appl. No.: 16/073,926

(22) PCT Filed: Jan. 23, 2017
(86) PCT No.: PCT/GB2017/050170

§ 371 Date: Jul. 30, 2018

(30) Foreign Application Priority Data
Jan. 22, 2016 (GB) 1601207.2

(51) Int. Cl. B68C 1/12; B68C 5/00

(52) U.S. Cl. CPC B68C 1/12; B68C 5/00

(57) ABSTRACT

A saddle pad (2) configured to be located in use between a saddle and a horse, wherein the saddle pad defines a spine (4) and a pair of opposed side portions (6), wherein each side portion extends outwardly away from the spine, wherein the spine includes a front portion (8), a rear portion (12) and a middle portion (10), and wherein in use the front, rear and middle portions of the spine together define a concave profile with the front and rear portions of the spine being elevationally higher than the middle portion, such that in use, the front portion and rear portion are spaced from the body of the horse.

The present invention relates to a saddle pad which is intended to be located in use between a horse and a saddle.

Known saddle pads comprise a spine portion and two side portions, wherein each side portion extends outwards from a respective side of the spine portion. In known saddle pads, the spine is either substantially linear (referred to herein as a square saddle pad) or has a front portion which is slightly elevated. In the context of the present invention, the terms “front”, “rear” and “side” are intended to indicate relative positions when the saddle pad is located for use on a horse.

However, the applicant has determined that known saddle pads, such as square saddle pads can apply pressure to a region of the equine lumbar spinous processes behind a saddle. Such pressure can be detrimental to the health and wellbeing of a horse, especially over time.

The present invention seeks to address this issue.

According to a first aspect of the present invention, there is provided a saddle pad configured to be located in use between a saddle and a horse, wherein the saddle pad defines a spine and a pair of opposed side portions, wherein each side portion extends outwardly away from the spine, wherein the spine includes a front portion, a rear portion and a middle portion, and wherein in use the front, rear and middle portions of the spine together define a concave profile with the front and rear portions of the spine being elevationally higher than the middle portion, such that in use, the front portion and rear portion are spaced from the body of the horse.

By spacing the rear of the saddle pad from the lumbar spinous processes of the horse, the pressure resulting from the use of a conventional saddle pad is reduced or avoided.

It will be appreciated that the spine and associated side portions are shaped such that in use, the front portion and rear portion of the spine are spaced from the body of the horse.

In an embodiment of the invention, the rear portion of the spine may define in use an angle of +/−20° from a vertical plane perpendicular to the longitudinal axis of the spine portion. In this way, the rear portion is spaced from the lumbar spinous processes behind the saddle and may also form a visible surface upon which indicia may be located. The indicia may be printed, embroidered, stitched, pinned, etc.

In order to allow the rear portion of the spine to project upwards behind the saddle, the rear edge of each side portion suitably curves forward.

The saddle pad may be formed from a padded or quilted material. Additionally or alternatively, it may define one or more reinforced areas.

The saddle pad may be used as a sole layer between a saddle and a horse or it may be used as one of two or more layers located between the saddle and the horse.

According to a second aspect of the invention, there is provided a combination of a saddle and a saddle pad as defined anywhere hereinabove, wherein the spine of the saddle pad corresponds in shape to the shape of the underside of the saddle and wherein the rear of the saddle pad extends beyond the rear of the saddle in use.

As noted above, the front and rear portions of the saddle pad spine are spaced from the corresponding parts of the horse in use.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

Embodiments of the invention will now be described, by way of example only, with reference to the accompanying drawings in which:

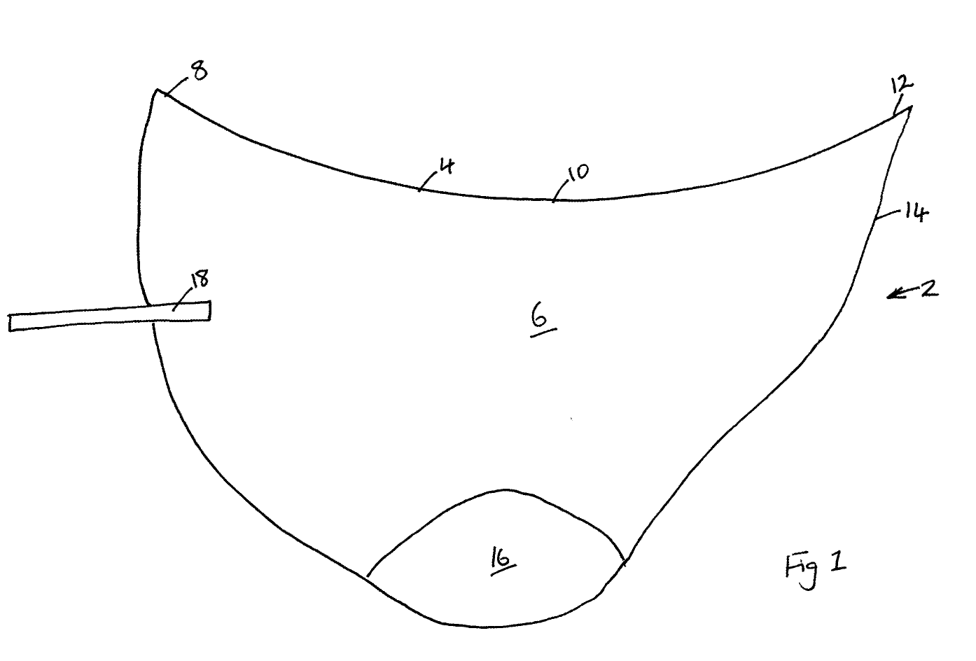

FIG. 1 is a side elevational view of a saddle pad according to an embodiment of the first aspect of the invention; and

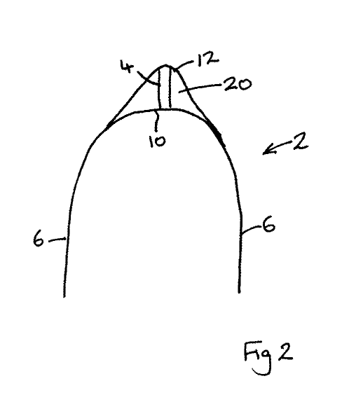

FIG. 2 is a rear elevational view of the saddle pad according to FIG. 1.

For the avoidance of doubt, the skilled person will appreciate that in this specification, the terms “up”, “down”, “front”, “rear”, “upper”, “lower”, “width”, etc. refer to the orientation of the saddle pad as found in the example when located for normal use on a horse and as shown in the Figures.

FIG. 1 shows a saddle pad 2 having a spine 4 and a pair of opposed side portions 6 (only one side portion is shown in FIG. 1), wherein each side portion 6 extends outwardly from the spine 4.

As can be seen from FIG. 1, the spine 4 has a front portion 8, a middle or central portion 10 and a rear portion 12. The spine 4 defines a concave shape in which the front portion 8 and the rear portion 12 are elevationally higher than the middle portion 10. By having the front portion 8 and the rear portion 12 higher than the middle portion 10, the front portion 8 and the rear portion 10 are spaced from the body of the horse in use.

As can also be seen from FIG. 1, the rear edges 14 of the side portions 6 curve forwards. This allows the rear portion 12 to adopt an upright configuration in use (as shown in FIG. 2 and described hereinbelow).

The saddle pad 2 further includes a reinforced portion 16 at a lower portion of each side portion 6 and a strap 18 for securing the saddle pad 2 around the chest of a horse in use. Such features are known in the context of saddle pads.

FIG. 2 shows a rear elevational view of the saddle pad 2. As can be seen in FIG. 2, when the saddle pad 2 is arranged in location on a horse and a saddle (not shown) is placed over the saddle pad 2, the rear portion 12 projects upwards. The rear portion 12 is arranged substantially vertical in this embodiment, but it will be appreciated that the rear portion 12 may be angled from a vertical plane, for example by up to 20° or so from a vertical plane. The upwardly projecting rear portion 12 defines an upright, rearward facing, visible surface 20. It will be appreciated by those skilled in the art that indicia, such as information about the horse and/or rider or promotional indicia, may be carried by the visible surface 20.

### EXAMPLE

A trial was carried out to compare a saddle pad according to the first aspect of the invention (hereinafter “HRP saddle pad”) and a straight cut conventional square saddle pad (hereinafter “Control saddle pad”).

Both the HRP saddle pad and the Control saddle pad were formed from the same material.

Study Design

The study was carried out as a two condition counter-balanced repeated measures crossover design using six horse. The horses ranged between 164 and 174 cm and competing at BE 100 and BE Novice level were used in the study. The horse's regular rider rode the horses during the study. All horses were ridden in their usual jumping saddle. The saddles were checked by a qualified saddle fitter at the start of the study and all were deemed to be a suitable fit.

Equipment

A Tekscan Conformat pressure mat system was calibrated according to the manufacturer's instructions using load calibration before each session. The mean pressures (mmHg) were recorded at five frames per second using the Tekscan Research software for an area corresponding to the lumbar dorsal spinous processes, with the position of the rear (most caudal aspect) of the saddle pad in its centre.

Protocol

The pressure mat was placed on the horse and the position marked using a safe, indelible marker in such a way as to allow the same pressure mat, pad and saddle placement in subsequent trials. The pressure mat was positioned to extend at least 5cm beyond the rearmost portion of the saddle pad. The saddle pad was located such that the front of the saddle pad was placed over the highest part of the horse's wither. The saddle was positioned so that the front of the flap was aligned with the front of the saddle pad. The girth was fatted and adjusted in the standard way for both saddle pads.

Once the horse was tacked up, the rider mounted from a mounting block. All sessions were conducted in the same 20 m×40 m arena. The horse and rider warmed up for 10 minutes in walk, trot and canter. The horse and rider then began the data collection session. The horse was walked for 2 minutes, trotted for 4 minutes (2 minutes sitting trot and 2 minutes rising trot) and cantered (medium canter) for 2 minutes. Measurements were taken as the horse passed a measurement point in the arena. Three separate sets of data were collected for each gait.

When the data collection session was completed, the horse was halted and the saddle pad was changed. A second data collection session was then carried out with the other saddle pad in accordance with the above protocol.

The data were then analysed and a Wilcoxon's test for matched pairs was carried out on the mean pressure data recorded using a commercial statistics package.

Results

As can be seen from the table below (Table 1), the mean pressure behind the saddle for all gaits was significantly lower for the HRP saddle pad compared with the Control saddle pad. During the trot and canter, no detectable pressure was recorded for the HRP saddle pad.

TABLE 1

MEAN PRESSURE (kPa)

| GAIT | HRP saddle pad | Control saddle pad |
|---|---|---|
| Stand | 0.4 | 4.8 |
| Walk | 0.2 | 3.3 |
| Sitting trot | 0.0 | 3.3 |
| Rising trot | 0.0 | 2.7 |
| Canter | 0.0 | 3.1 |

The evidence of the trial clearly shows that the exemplified saddle pad significantly reduced pressure on the dorsal lumbar spinous region behind the saddle of a horse.

1. A saddle pad configured to be located in use between a saddle and a horse, wherein the saddle pad defines a spine and a pair of opposed side portions, wherein each side portion extends outwardly away from the spine, wherein the spine includes a front portion, a rear portion and a middle portion, and wherein in use the front, rear and middle portions of the spine together define a concave profile with the front and rear portions of the spine being elevationally higher than the middle portion, such that in use, the front portion and rear portion are spaced from the body of the horse.

2. A saddle pad according to claim 1, wherein the rear portion defines an angle of +/−20° from a vertical plane perpendicular to the longitudinal axis of the spine.

3. A saddle pad according to claim 2, wherein the rear edge of each side portion curves forward.

4. A combination of a saddle and a saddle pad according to claim 3, wherein the spine of the saddle pad corresponds in shape to the shape of the underside of the saddle, and wherein the rear of the saddle pad extends beyond the rear of the saddle.
